(19) United States
(12) Patent Application Publication
(10) Pub. No.: US 2016/0010492 A1
(43) Pub. Date: Jan. 14, 2016

(54) POSITION SENSOR PLACEMENT FOR ELECTRICALLY ASSISTED TURBOCHARGER

(71) Applicant: BORGWARNER INC., Auburn Hills, MI (US)

(72) Inventor: Augustine Cavagnaro, Flat Rock, NC (US)

(21) Appl. No.: 14/378,982

(22) PCT Filed: Feb. 11, 2013
(86) PCT No.: PCT/US13/25521

§ 371 Date: Aug. 15, 2014

Related U.S. Application Data
(60) Provisional application No. 61/600,126, filed on Feb. 17, 2012.

(51) Int. Cl. F01D 21/00; F02B 39/10; F01D 25/28; F02B 33/40; F01D 5/02; F01D 15/10

(52) U.S. Cl. CPC F01D 21/003; F01D 5/02; F01D 15/10; F01D 25/28; F02B 33/40; F02B 39/10; F05D 2220/40; F05D 2260/83

(57) ABSTRACT

An electrically assisted turbocharger (10) includes an electric motor (70) having a rotor (72) and a stator (74). The rotor (72) rotates in response to operation of the turbocharger (10) and the stator (74) is fixed relative to the rotor (72). A component (40, 48, 24) rotates in unison with the rotor (72) and includes a plurality of features (80, 84, 86, 90). To control timing of phase excitation of the electric motor (70), a position sensor (82) is mounted to the turbocharger (10) to detect the plurality of features (80, 84, 86, 90) on the rotating component (40, 48, 24) to determine a rotational position of the rotor (72).

### CROSS-REFERENCE TO RELATED APPLICATIONS

This application claims priority to and all the benefits of U.S. Provisional Application No. 61/600,126, filed on Feb. 17, 2012, and entitled “Position Sensor Placement For Electrically Assisted Turbocharger.”

### BACKGROUND OF THE INVENTION

1. Field of the Invention

This invention relates to an electrically assisted turbocharger for an internal combustion engine. More particularly, this invention relates to a method of sensing rotor position in an electrically assisted turbocharger.

2. Description of Related Art

A turbocharger is a type of forced induction system used with internal combustion engines. Turbochargers deliver compressed air to an engine intake, allowing more fuel to be combusted, thus boosting an engine's horsepower without significantly increasing engine weight. Thus, turbochargers permit the use of smaller engines that develop the same amount of horsepower as larger, normally aspirated engines. Using a smaller engine in a vehicle has the desired effect of decreasing the mass of the vehicle, increasing performance, and enhancing fuel economy. Moreover, the use of turbochargers permits more complete combustion of the fuel delivered to the engine, which contributes to the highly desirable goal of a cleaner environment.

Turbochargers typically include a turbine housing connected to the engine's exhaust manifold, a compressor housing connected to the engine's intake manifold, and a center bearing housing coupling the turbine and compressor housings together. A turbine wheel in the turbine housing is rotatably driven by an inflow of exhaust gas supplied from the exhaust manifold. A shaft rotatably supported in the center bearing housing connects the turbine wheel to a compressor impeller in the compressor housing so that rotation of the turbine wheel causes rotation of the compressor impeller. The shaft connecting the turbine wheel and the compressor impeller defines an axis of rotation. As the compressor impeller rotates, it increases the air mass flow rate, airflow, density and air pressure delivered to the engine's cylinders via the engine's intake manifold.

To further improve engine efficiency, it is known to integrate an electric motor into the shaft of the turbocharger. This type of turbocharger is referred to as an electrically assisted turbocharger. In such a configuration, the motor is energized at low engine speeds to impart additional rotation to the shaft, which increases rotation of the compressor impeller in order to minimize turbo lag. The electric motor can also be used as a generator, which converts shaft work into electrical power. The electrical power produced by the generator can be used to run auxiliary electrical components or to run a motor mounted on the engine crankshaft, recovering otherwise wasted energy in the exhaust gas.

One example of an electric motor that is integrated into the shaft of the turbocharger is a switched reluctance motor (SRM). The principles of operation of SRMs are simple, well known, and based on reluctance torque. SRMs have a stator with concentrated windings and a rotor with no winding. In the electrically assisted turbocharger, the rotor is incorporated with the shaft of the turbocharger and the stator surrounds the rotor. A typical SRM may have six stator poles and four rotor poles, denoted as a “6/4 SRM.” The 6/4 SRM has three phases, each phase consisting of two windings on opposite stator poles. The windings in one phase are simultaneously energized and generate a magnetic flux. The magnetic flux created by the windings follows the path of least magnetic reluctance, meaning the flux will flow through the rotor poles that are closest to the energized stator poles, thereby magnetizing those rotor poles and causing the rotor to align itself with the energized stator poles. Electromagnetic torque is produced by the tendency of the rotor poles to align with the energized stator poles. As the rotor turns, different phases will be sequentially energized to keep the rotor turning. For use as a generator, the phases are energized when the stator poles and rotor poles are separating, rather than when they are approaching. Thus, controlling the timing of phase excitation, whether as a motor or generator, is important to the operation of the electrically assisted turbocharger.

In order to properly control the timing of phase excitation, accurate position sensing of the rotor relative to the stator is required. It is desirable, therefore, to provide an electrically assisted turbocharger having simple and accurate position sensing for a rotor of an electric motor.

### SUMMARY OF THE INVENTION

According to one aspect of the invention, an electrically assisted turbocharger includes a turbine wheel mounted on one end of a shaft and a compressor impeller mounted on an opposite end of the shaft. The shaft and compressor impeller rotate in response to rotation of the turbine wheel. A rotor of an electric motor is fixed to the shaft between the turbine wheel and the compressor impeller and rotates with the shaft. A stator of the electric motor is fixed relative to the rotor. A component, such as a compressor nut, flinger sleeve, or the compressor impeller, rotates with the shaft and includes a plurality of features such as flats, lobes, or scallops. A position sensor is mounted to the turbocharger and arranged to detect the plurality of features on the rotating component which is used to determine a rotational position of the rotor in order to control timing of phase excitation in the electric motor.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a cross-sectional view of an electrically assisted turbocharger including an electric motor;

FIG. 2 is a cross-sectional view of a rotor of the electric motor mounted on a shaft of a turbine wheel;

FIG. 3A is a perspective view of a compressor nut including a plurality of features according to one embodiment of the invention;

FIG. 3B is an end view of the compressor nut shown in FIG. 3A illustrating one location for a position sensor;

FIG. 4A is a partially cut-away cross-sectional view of a flinger sleeve including a plurality of features and an insert according to another embodiment of the invention illustrating another location for the position sensor;

FIG. 4B is an end view of the flinger wheel shown in FIG. 4A;

FIG. 5A is a partially cut-away cross-sectional view of a compressor impeller including a plurality of features according to yet another embodiment of the invention illustrating another location for the position sensor;

FIG. 5B is a back end view of the compressor impeller shown in FIG. 5A; and

FIG. 6 is a front end view of the compressor impeller including a plurality of scallop cuts according to still another embodiment of the invention.

### DETAILED DESCRIPTION OF THE EMBODIMENTS

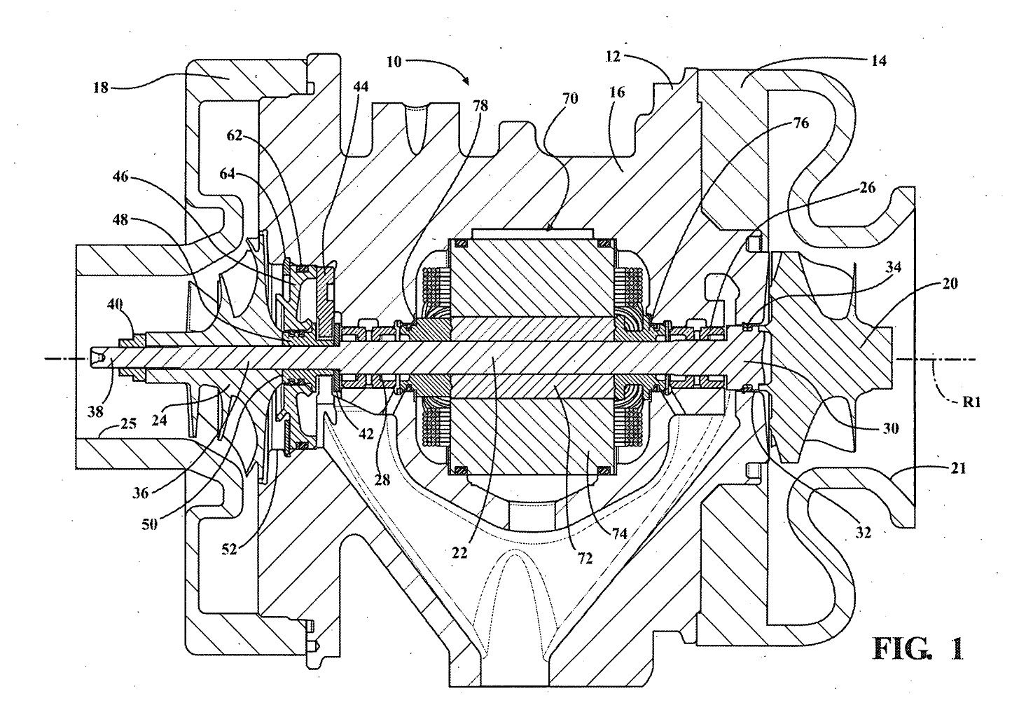

Referring to the Figures, a turbocharger is illustrated generally at 10 in FIG. 1. The turbocharger 10 includes a housing assembly 12 consisting of a turbine housing 14, a bearing housing 16, and a compressor housing 18 that are connected to each other. A turbine wheel 20 is disposed in the turbine housing 14 and is rotatably driven by an inflow of exhaust gas supplied from an engine exhaust manifold. After driving the turbine wheel 20, the exhaust gas is discharged from the turbine housing 14 through a central exit pipe or exducer 21. A shaft 22 that is rotatably supported in the bearing housing 16 connects the turbine wheel 20 to a compressor impeller 24 in the compressor housing 18 such that rotation of the turbine wheel 20 causes rotation of the compressor impeller 24. The shaft 22 connecting the turbine wheel 20 and the compressor impeller 24 defines an axis of rotation R1. As the compressor impeller 24 rotates, air is drawn into the compressor housing 18 through an inlet passage 25 and is compressed to be delivered at an elevated pressure to an engine intake manifold.

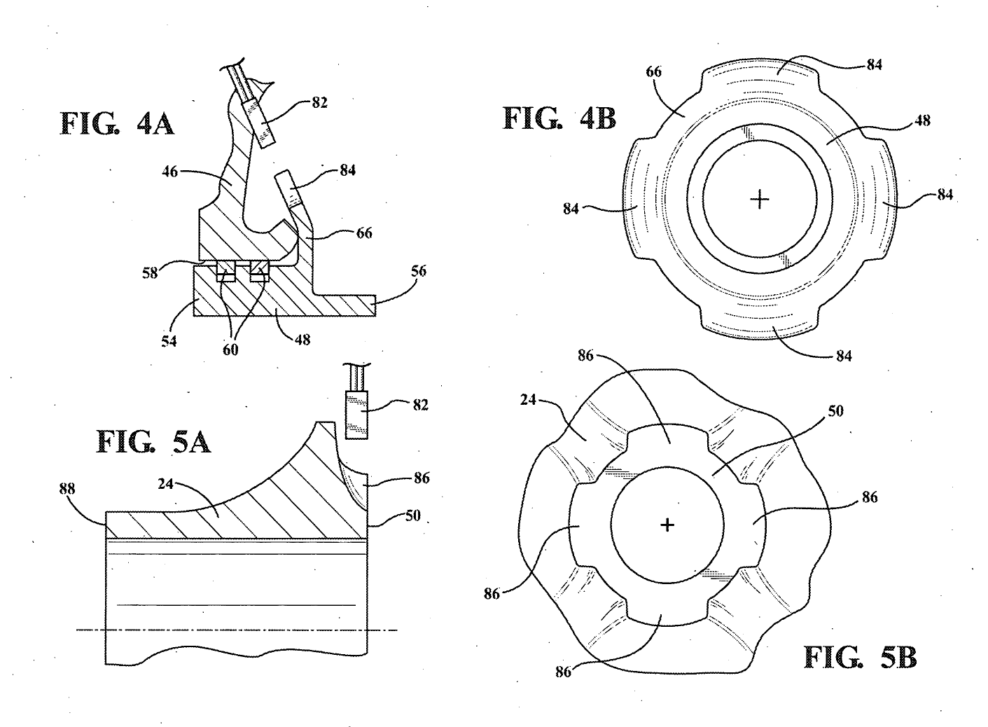

The shaft 22 is rotatably supported in the bearing housing 16 by a pair of spaced apart journal bearings 26, 28. The turbine wheel 20 is typically butt welded to one end of the shaft 22 directly adjacent to an enlarged shoulder portion 30 of the shaft 22. The shaft 22 enters the bearing housing 16 though a piston ring bore 32 that is formed in a turbine side of the bearing housing 16. The shoulder portion 30 is disposed in the piston ring bore 32. A piston ring 34 is seated in a groove on the shoulder portion 30 and forms a seal between the shaft 22 and the bearing housing 16. An opposite end of the shaft 22 has a reduced diameter portion 36 on which the compressor impeller 24 is mounted. A distal end 38 of the shaft 22 is threaded and a compressor nut 40 securely retains the compressor impeller 24 to the shaft 22. Adjacent to the journal bearing 28, the reduced diameter portion 36 of the shaft 22 carries a thrust washer 42 that cooperates with a stationary thrust bearing member 44 to handle axial loads in the turbocharger 10. The reduced diameter portion 36 also carries an insert 46 and a flinger sleeve 48 that are located directly adjacent to a back-wall 50 of the compressor impeller 24. The thrust washer 42, thrust bearing member 44, insert 46, and flinger sleeve 48 are assembled into a thrust bearing pocket 52 which is formed in a compressor side of the bearing housing 16. The insert 46 and flinger sleeve 48 cooperate to prevent oil from being sucked into the compressor housing 14 and to keep the compressed air from leaking into the bearing housing 16. The flinger sleeve 48 includes an outer portion 54 that is adjacent to the compressor impeller 24 and an inner portion 56 that is adjacent to the thrust washer 42, best seen in FIG. 4A. The shaft 22 exits the bearing housing 16 through a piston ring bore 58 that is formed in the insert 46. The flinger sleeve 48 rotates with the shaft 22 and the outer portion 54 thereof is disposed in the piston ring bore 58. A piston ring 60 is seated in a groove on the outer portion 54 of the flinger sleeve 48 and forms a seal between the flinger sleeve 48 and an inner circumference of the insert 46. An O-ring 62 is seated in a groove on an outer circumference of the insert 46 and forms a seal between the insert 46 and the bearing housing 16. A snap ring 64 secures the insert 46 in place. The inner portion 56 of the flinger sleeve 48 is disposed in a bore of the thrust bearing member 44. The flinger sleeve 48 also includes a lip 66 between the outer and inner portions 54, 56 having a circumference that is larger than the circumference of each of the outer and inner portions 54, 56. The lip 66 is disposed between the insert 46 and the thrust bearing member 44.

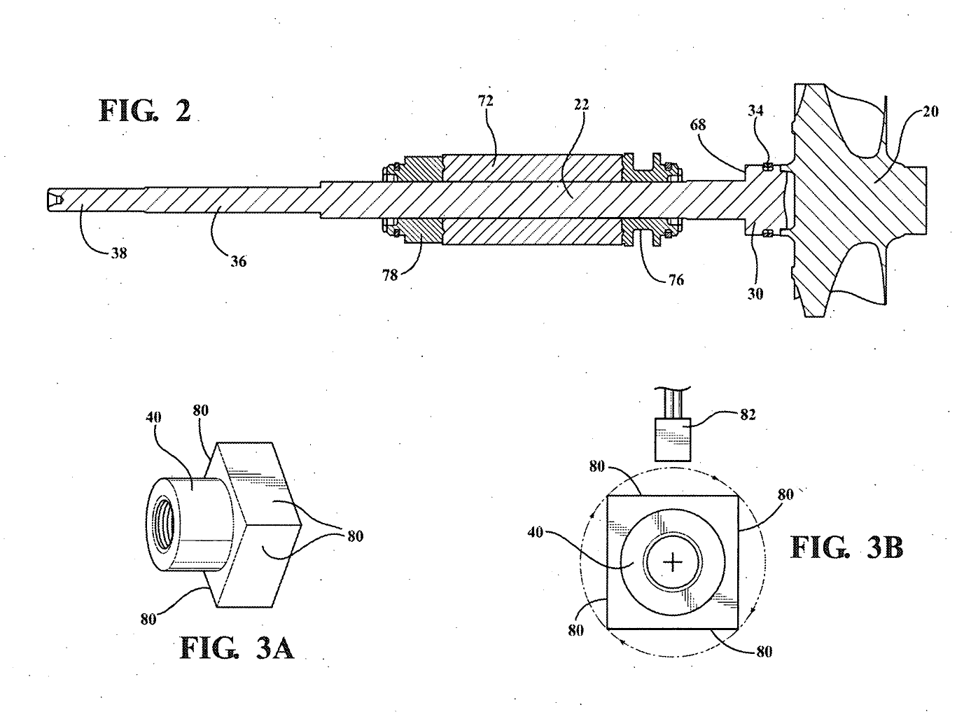

Oil circulates through the bearing housing 16 to provide lubrication to the journal bearings 26, 28 and to remove heat that comes from the turbine housing 14. The exhaust gas is prevented from entering the bearing housing 16 on the turbine side by the piston ring 34. Similarly, the compressed air is prevented from entering the bearing housing 16 on the compressor side by the piston ring 60. On the turbine side, oil leaving the journal bearing 26 is picked up by a face 68 of the shoulder portion 30, best seen in FIG. 2, as the shaft 22 rotates and is directed into a first slot which opens into an oil drain cavity of the bearing housing 16. On the compressor side, oil leaving the journal bearing 28 is picked up by the lip 66 of the flinger sleeve 48 as the shaft 22 rotates and is directed into a second slot which also opens into the oil drain cavity of the bearing housing 16.

An electric motor is incorporated into the turbocharger 10. In the present embodiment, the motor is a switched reluctance motor (SRM), generally shown at 70. It is appreciated, however, that the electric motor may be any suitable motor without varying from the scope of the invention. The SRM 70 is disposed in the bearing housing 16 generally between the spaced apart journal bearings 26, 28. The SRM 70 includes a rotor 72 that rotates with the shaft 22 and a stator 74 with concentrated windings that is stationary and circumferentially surrounds the rotor 72. In the present embodiment, the rotor 72 has four rotor poles and the stator 74 has six stator poles. A collar 76 on the turbine side is fixed to the shaft 22 and acts as a spacer between the journal bearing 26 and the rotor 72. Similarly, a collar 78 on the compressor side is fixed to the shaft 22 and acts as a spacer between the journal bearing 28 and the rotor 72. In order to properly control the timing of phase excitation in the SRM, accurate position sensing of the rotor 72 is required, as is well known to one skilled in the art. However, due to space constraints and extreme conditions in certain areas within the housing assembly 12, there are relatively few locations for arranging a conventional position sensor to detect rotor position. Since the shaft 22 rotates in unison with the rotor 72, accurate position sensing of the shaft 22 will satisfy this requirement. Likewise, any rotating component associated with the rotor 72 can be used to facilitate position sensing of the rotor 72. Flats, lobes, scallops, or other features can be added to these rotating components for detection by a position sensor. It is contemplated that the position sensor may be any type of sensor that is suitable for monitoring these features, such as a magnetic pickup (Hall effect) sensor or a reflective type (optical) sensor. It is further contemplated that various factors will all play a role in the type of position sensor that is used. For example, whether the features are magnetic or non-magnetic, shape and size of the features, and the proximity of the position sensor relative to the features.

In the present embodiment, it is convenient to add four features to a rotating component in the turbocharger 10 to correspond with the number of poles of the rotor 72 in order to simplify the control and electronics required for phase excitation of the SRM 70. It is appreciated, however, that fewer or more features may be used without varying from the scope of the invention. Further, it may be desirable to orient or “clock” the features on the rotating component such that the features are aligned with the poles of the rotor 72, however, such alignment of the features with the poles is not necessary.

In one embodiment of the invention, shown in FIGS. 3A and 3B, an outer periphery or circumference of the compressor nut 40 has four features 80 and a position sensor 82 is mounted within the inlet passage 25 of the compressor housing 18 to detect the features 80 during rotation of the shaft 22. In the embodiment shown, the features 80 are flats, however, the features 80 may have some other form without varying from the scope of the invention. In addition, the features 80 are shown to be spaced equally around the circumference of the compressor nut 40. In other words, the features 80 are spaced equally around the axis of rotation R1. However, it is not necessary for the features 80 to be spaced equally around the axis of rotation R1.

In another embodiment of the invention, shown in FIGS. 4A and 4B, an outer periphery or circumference of the flinger sleeve 48 has four features 84 and the position sensor 82 is affixed to the insert 46 to detect the features 84 during rotation of the shaft 22. The features 84 are positioned adjacent to the thrust bearing member 44. In the embodiment shown, the features 84 are lobes, however, the features 84 may have some other form without varying from the scope of the invention. More specifically, the features 84 extend radially outwardly from the lip 66 and arc shown to be spaced equally around the circumference of the lip 66. In other words, the features 84 are spaced equally around the axis of rotation R1. However, it is not necessary for the features 84 to be spaced equally around the axis of rotation R1.

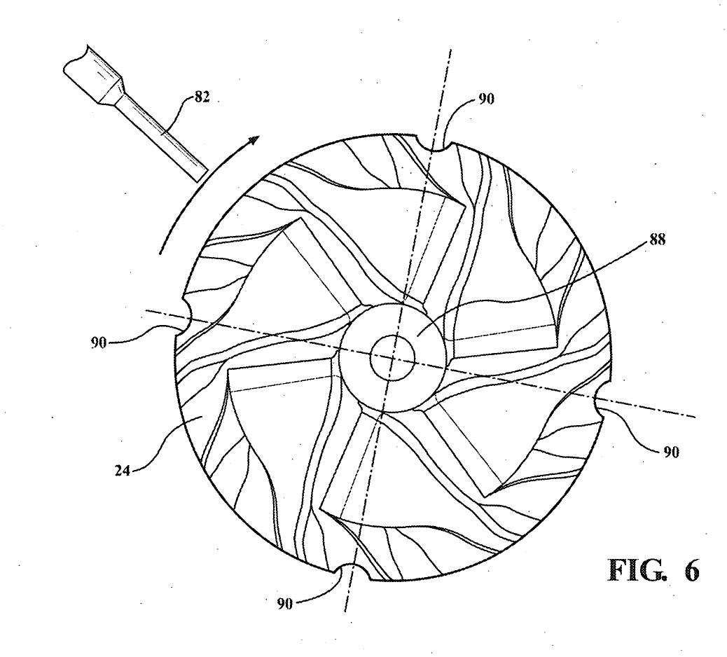

In yet another embodiment of the invention, shown in FIGS. 5A and 5B, an outer periphery of the compressor impeller 24, adjacent to the back-wall 50 of the compressor impeller 24, has four features 86 and the position sensor 82 is located in the compressor side of the bearing housing 16 to detect the features 86 during rotation of the shaft 22. In the embodiment shown, the features 86 are lobes, however, the features 86 may have some other form without varying from the scope of the invention. In addition, the features 86 are shown to be spaced equally around the outer periphery of the compressor impeller 24. In other words, the features 86 are spaced equally around the axis of rotation R1. However, it is not necessary for the features 86 to be spaced equally around the axis of rotation R1. It is contemplated that the features 86 may be located on a nose 88 of the compressor impeller 24 adjacent to the compressor nut 40, on the back-wall 50 of the compressor impeller 24, or on an outer periphery of the back-wall 50, without varying from the scope of the invention. In such instances, the position sensor 82 is located within the turbocharger 10 in a manner to detect the features 86 accordingly. It is further contemplated that in addition to position sensing, the features 86 on or adjacent to the back-wall 50 of the compressor impeller 24 can be used for balance correction of the compressor impeller 24. As such, the features 86 may not be equally sized. It is appreciated that the compressor impeller 24 is typically made from aluminum. As such, the position sensor 82 would be an optical sensor rather than a magnetic sensor.

In still another embodiment of the invention, shown in FIG. 6, an outer periphery of the back-wall 50 of the compressor impeller 24 has four features 90 and the position sensor 82 is located generally in the compressor housing 18 and/or compressor side of the bearing housing 16 to detect the features 90 during rotation of the shaft 22. The position sensor 82 may be positioned radially, axially, or at some angle therebetween. In the embodiment shown, the features 90 are scallop cuts, however, the features 90 may have some other form without varying from the scope of the invention. The features 90 are shown to be spaced equally around the outer periphery of the back-wall 50. In other words, the features 90 are spaced equally-around the axis of rotation R1. However, it is not necessary for the features 90 to be spaced equally around the axis of rotation R1. It is contemplated that in addition to position sensing, the features 90 on the outer periphery of the back-wall 50 of the compressor impeller 24 can be used for balance correction of the compressor impeller 24. As such, the features 90 may not be equally sized.

The invention has been described here in an illustrative manner, and it is to be understood that the terminology used is intended to be in the nature of words of description rather than limitation. Many modifications and variations of the present invention are possible in light of the above teachings. It is, therefore, to be understood that within the scope of the appended claims, the invention may be practiced other than as specifically enumerated within the description.

What is claimed:

1. An electrically assisted turbocharger (10) comprising:
a rotor (72) rotating in response to operation of said turbocharger (10);
a stator (74) fixed relative to said rotor (72);
a component (40, 48, 24) rotating in unison with said rotor (72), said component (40, 48, 24) including a plurality of features (80, 84, 86, 90); and
a position sensor (82) mounted to said turbocharger (10) for detecting said plurality of features (80, 84, 86, 90) on said component (40, 48, 24) during rotation thereof to determine a rotational position of said rotor (72).

2. An electrically assisted turbocharger (10) comprising:
a shaft (22) rotating in response to operation of said turbocharger (10);
a rotor (72) fixed to said shaft (22) for rotation therewith;
a stator (74) fixed relative to said rotor (72);
a component (40, 48, 24) fixed to said shaft (22) for rotation therewith, said component (40, 48, 24) including a plurality of features (80, 84, 86, 90); and
a position sensor (82) mounted to said turbocharger (10) for detecting said plurality of features (80, 84, 86, 90) on said component (40, 48, 24) during rotation of said component (40, 48, 24) to determine a rotational position of said rotor (72).

3. The electrically assisted turbocharger (10) as set forth in claim 2 wherein said component is a compressor nut (40) coupled to said shaft (22) for rotation therewith, and wherein an outer periphery of said compressor nut includes said plurality of features (80).

4. The electrically assisted turbocharger (10) as set forth in claim 2 wherein said component is a flinger sleeve (48) coupled to said shaft (22) for rotation therewith, and wherein an outer periphery of said flinger sleeve (48) includes said plurality of features (84).

5. The electrically assisted turbocharger (10) as set forth in claim 2 wherein said component is a compressor impeller (24) coupled to said shaft (22) for rotation therewith, and wherein an outer periphery of said compressor impeller (24) includes said plurality of features (86, 90).

6. The electrically assisted turbocharger (10) as set forth in claim 5 wherein said shaft (22) defines an axis of rotation (R1), and wherein said plurality of features (86, 90) are spaced equally around said axis of rotation (R1).

7. The electrically assisted turbocharger (10) as set forth in claim 5 wherein said shaft (22) defines an axis of rotation (R1), and wherein said plurality of features (86, 90) not spaced equally around said axis of rotation (R1).

8. The electrically assisted turbocharger (10) as set forth in claim 5 wherein said plurality of features (86, 90) are not equally sized.

9. An electrically assisted turbocharger (10) including an electric motor (70), said turbocharger (10) comprising:
a shaft (22);
a turbine wheel (20) mounted on one end of said shaft (22), wherein said shaft (22) rotates in response to rotation of said turbine wheel (20);
a compressor impeller (24) mounted on an opposite end of said shaft (22) for rotation therewith;
a rotor (72) fixed to said shaft (22) between said turbine wheel (20) and said compressor impeller (24), said rotor (72) rotating with said shaft (22);
a stator (74) fixed relative to said rotor (72);
a component (40, 48, 24) fixed to said shaft (22) for rotation therewith, said component (40, 48, 24) including a plurality of features (80, 84, 86, 90); and
a position sensor (82) mounted to said turbocharger (10) for detecting said plurality of features (80, 84, 86, 90) on said component (40, 48, 24) during rotation of said component (40, 48, 24) to determine a rotational position of said rotor (72).

10. The electrically assisted turbocharger (10) as set forth in claim 9 wherein said component is a compressor nut (40) retaining said compressor impeller (24) on said shaft (22), said compressor nut (40) including an outer periphery having said plurality of features (80).

11. The electrically assisted turbocharger (10) as set forth in claim 9 wherein said component is a flinger sleeve (48) disposed between said compressor impeller (24) and said rotor (72), said flinger sleeve (48) including an outer periphery having said plurality of features (84).

12. The electrically assisted turbocharger (10) as set forth in claim 12 including an insert (46) disposed between said compressor impeller (24) and said rotor (72), wherein said insert (46) includes a piston ring bore (58) and said flinger sleeve (48) includes an outer portion (54) disposed in said piston ring bore (58), and wherein said position sensor (82) is mounted on said insert (46) to detect said plurality of features (84) during rotation of said flinger sleeve (48).

13. The electrically assisted turbocharger (10) as set forth in claim 9 wherein said compressor impeller (24) includes an outer periphery having said plurality of features (86, 90).

14. The electrically assisted turbocharger (10) as set forth in claim 13 wherein said shaft (22) defines an axis of rotation (R1), and wherein said plurality of features (86, 90) are not spaced equally around said axis of rotation (R1).

15. The electrically assisted turbocharger (10) as set forth in claim 14 wherein said plurality of features (86, 90) are not equally sized.
